(19) United States
(12) Patent Application Publication
(10) Pub. No.: US 2010/0011367 A1
(43) Pub. Date: Jan. 14, 2010

(54) METHODS AND SYSTEMS FOR ALLOCATING A RESOURCE OF A VEHICLE AMONG A PLURALITY OF USES FOR THE RESOURCE

(75) Inventor: Susanta P. Sarkar, Rochester Hills, MI (US)

Correspondence Address: INGRASSIA FISHER & LORENZ, P.C. (GM), 7010 E. COCHISE ROAD, SCOTTSDALE, AZ, 85253, US

(73) Assignee: GM GLOBAL TECHNOLOGY OPERATIONS, INC., DETROIT, MI (US)

(21) Appl. No.: 12/171,863

(22) Filed: Jul. 11, 2008

(51) Int. Cl. G06F 9/46

(52) U.S. Cl. 718/104

(57) ABSTRACT

A method for implementing a request pertaining to a requested use of a plurality of uses of a resource of a vehicle includes the steps of determining whether the resource is configured for simultaneous use by two or more of the plurality of uses, determining whether the resource is being used by an existing use of the plurality of uses, and allowing the requested use of the resource and the existing use of the resource, if the resource is configured for simultaneous use by two or more of the plurality of uses and the resource is being used by the existing use.

### TECHNICAL FIELD

The present invention generally relates to the field of vehicles and, more specifically to methods and systems for allocating resources in a vehicle among a plurality of uses for the resources.

### BACKGROUND OF THE INVENTION

Many of today's vehicles include a variety of different resources that each has a number of different potential uses for the vehicle occupants. For example, an audio resource of a vehicle may have many potential uses, such as a radio or compact disk player, a DVD entertainment system, a navigation system, a vehicle warning or alert system, or a cellular telephone or other communication feature. It is thus possible that multiple such uses can compete for the same resource of the vehicle.

Such resources in today's vehicles are typically allocated among various potential uses through standard arbitration algorithms. In such standard arbitration algorithms, the vehicle resources are allocated to multiple uses one at a time, based on the underlying presumption that only one use of a resource could be allowed at any particular time. However, such standard arbitration algorithms do not always provide desired behavior for the vehicle occupants. For example, music playing and alert presentation via audio could be superimposed in the same audio channel but music playing and speech recognition cannot be. It is possible to enumerate such behavior case by case basis, but that approach is cumbersome as the number of use grows.

Accordingly, it is desired to provide an improved method for allocating resources in a vehicle among multiple potential uses, for example that account for sharing certain resources among two or more potential uses under appropriate circumstances. It is also desired to provide an improved program product and/or an improved system for allocating resources in a vehicle among multiple potential uses, for example that provides some or all of the potential benefits mentioned above.

Furthermore, other desirable features and characteristics of the present invention will be apparent from the subsequent detailed description and the appended claims, taken in conjunction with the accompanying drawings and the foregoing technical field and background.

### SUMMARY OF THE INVENTION

In accordance with an exemplary embodiment of the present invention, a method for implementing a request pertaining to a requested use of a plurality of uses of a resource of a vehicle is provided. The method comprises the steps of determining whether the resource is configured for simultaneous use by two or more of the plurality of uses, determining whether the resource is being used by an existing use of the plurality of uses, and allowing the requested use of the resource and the existing use of the resource, if the resource is configured for simultaneous use by two or more of the plurality of uses and the resource is being used by the existing use.

In accordance with another exemplary embodiment of the present invention, a program product for implementing a request pertaining to a requested use of a plurality of uses of a resource of a vehicle is provided. The program product comprises a program and a computer-readable signal-bearing media. The program is configured to at least facilitate determining whether the resource is configured for simultaneous use by two or more of the plurality of uses, determining whether the resource is being used by an existing use of the plurality of uses, and allowing the requested use of the resource and the existing use of the resource, if the resource is configured for simultaneous use by two or more of the plurality of uses and the resource is being used by the existing use. The computer-readable signal-bearing media bears the program.

In accordance with a further exemplary embodiment of the present invention, a system for allocating a resource of a vehicle among a plurality of uses for the resource is provided. The system comprises an interface and a processor. The interface is configured to receive a request pertaining to a requested use of the plurality of uses. The processor is coupled to the interface, and is configured to at least facilitate determining whether the resource is configured for simultaneous use by two or more of the plurality of uses, determining whether the resource is being used by an existing use of the plurality of uses, and allowing the requested use of the resource and the existing use of the resource, if the resource is configured for simultaneous use by two or more of the plurality of uses and the resource is being used by the existing use.

### BRIEF DESCRIPTION OF THE DRAWINGS

The present invention will hereinafter be described in conjunction with the following drawing figures, wherein like numerals denote like elements, and wherein:

FIG. 1 is a flowchart of a process for allocating a resource of a vehicle among a plurality of uses for the resource, in accordance with an exemplary embodiment of the present invention;

FIG. 2 is a flowchart of a step of the process of FIG. 1, namely the step of implementing an exclusive allocation algorithm for the resource, in accordance with an exemplary embodiment of the present invention;

FIG. 3 is a flowchart of another step of the process of FIG. 1, namely the step of implementing a non-exclusive allocation algorithm for the resource, in accordance with an exemplary embodiment of the present invention;

FIG. 4 is a flowchart of another step of the process of FIG. 1, namely the step of implementing a de-allocation algorithm for the resource, in accordance with an exemplary embodiment of the present invention; and

FIG. 5 is a functional block diagram of a computer system for allocating a plurality of uses for a resource of a vehicle, and that can be implemented in connection with the process of FIG. 1, including the steps thereof of FIGS. 2-4, in accordance with an exemplary embodiment of the present invention.

### DETAILED DESCRIPTION OF THE INVENTION

The following detailed description is merely exemplary in nature, and is not intended to limit the invention or the application and uses of the invention. Furthermore, there is no intention to be bound by any expressed or implied theory presented in the preceding technical field, background, brief summary or the following detailed description.

Embodiments of the invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present invention may be practiced in conjunction with any number of different inverters for any number of different types of vehicles.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the invention.

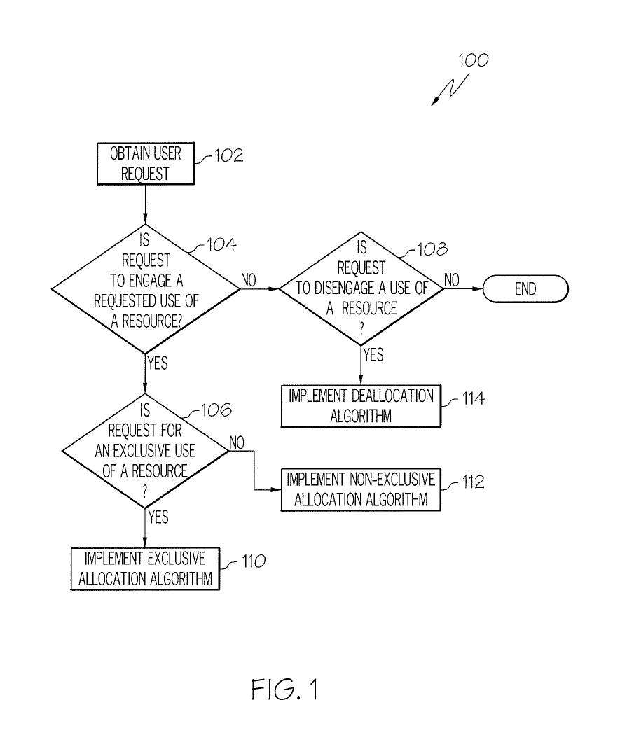

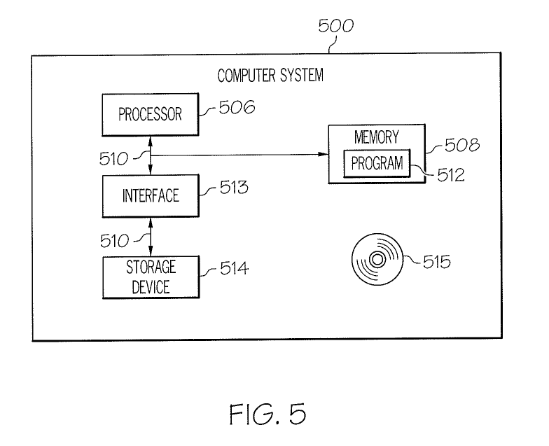

FIG. 1 is a flowchart of a process 100 for allocating a resource of a vehicle among multiple uses, in accordance with an exemplary embodiment of the present invention. In a preferred embodiment, the process 100 can be implemented in connection with a system and/or program product such as the computer system 500 depicted in FIG. 5 and/or a program product that includes the program 512 depicted in FIG. 5 as will be described further below in connection with FIG. 5.

As depicted in FIG. 1, the process 100 begins with the step of obtaining a request from a requester (step 102). The request pertains to one or more desired uses of a resource of a vehicle from the requester. For example, in the above-mentioned example of an audio resource of a vehicle, the desired uses may include one or more of the following: as a radio or compact disk player, a DVD entertainment system, a navigation system, a vehicle warning or alert system, a cellular telephone or other communication feature, and/or any one or more of a number of other different types of uses. A vehicle driver, user, or other requester may initiate such a request, for example, by turning a dial on the vehicle radio, compact disk player or DVD player, by pressing a button on a cellular phone or other communication device, by making a voice command prompt, and/or by any one or more of a number of different types of techniques. In a preferred embodiment, the request is received by an interface of a computer system, such as the interface 513 of the computer system 500 of FIG. 5.

A determination is made as to whether the request includes a request to engage a requested use of a resource (step 104). If it is determined in step 204 that the request includes a request to engage a requested use of the resource (i.e., if the requester wishes to use the resource in any particular manner), then the process proceeds to step 106, in which a determination is made as to whether the request includes a request to engage in an exclusive use of the resource. Conversely, if it is determined in step 104 that the request does not include a request to engage a requested use of the resource, then the process proceeds instead to step 108, as discussed further below.

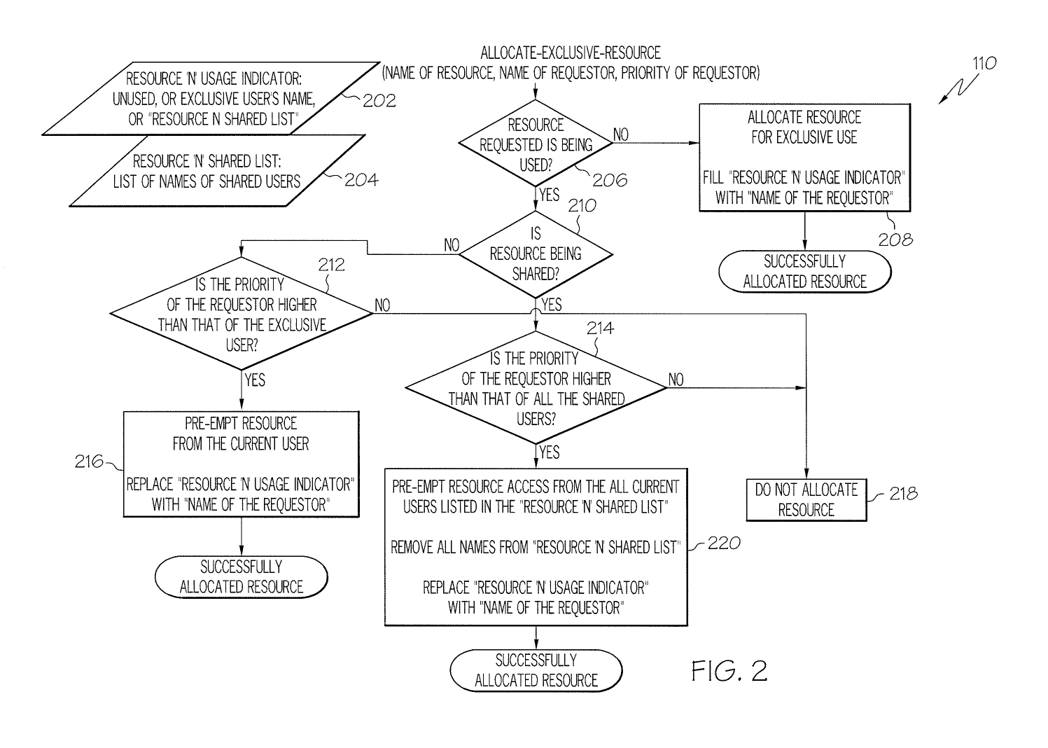

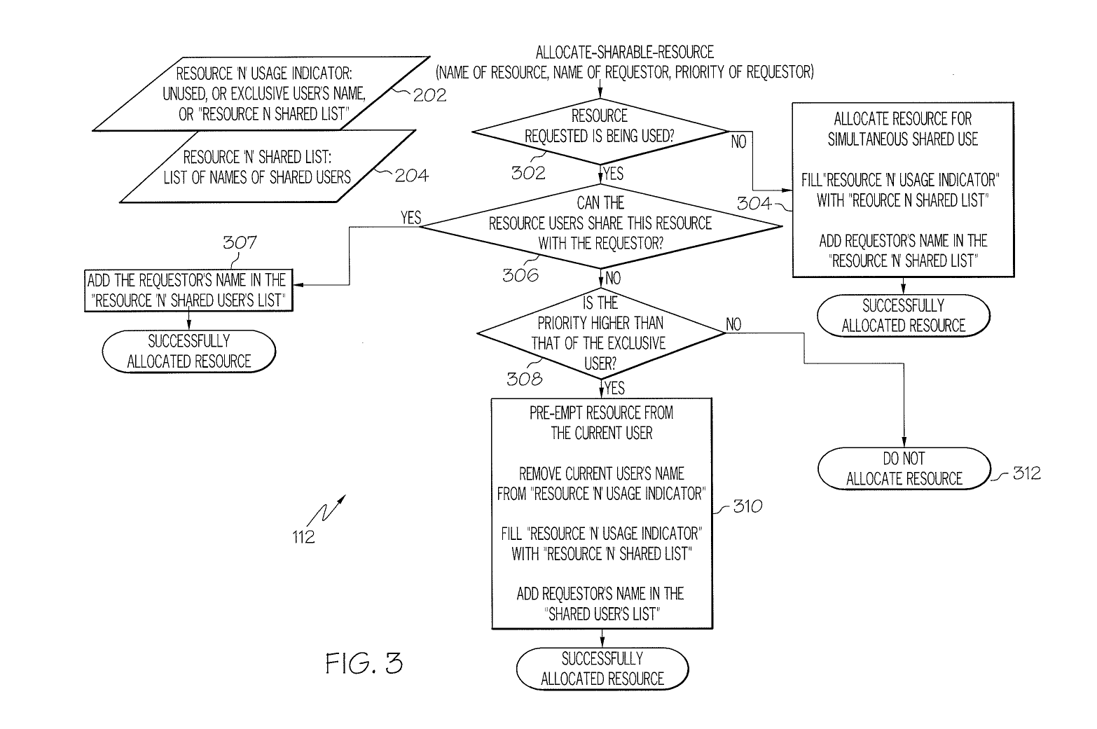

If it is determined in step 106 that the request includes a request to engage in an exclusive use of the resource, then the process proceeds to step 110, in which an exclusive allocation algorithm is implemented. The exclusive allocation algorithm of step 110 is depicted in FIG. 2 in accordance with an exemplary embodiment of the present invention, and will be described further below in connection therewith. Conversely, if it is determined in step 106 that the request does not include a request to engage in an exclusive use of the resource, then the process proceeds instead to step 112, in which a non-exclusive allocation algorithm is implemented. The non-exclusive allocation algorithm of step 112 is depicted in FIG. 3 in accordance with an exemplary embodiment of the present invention, and will be described further below in connection therewith.

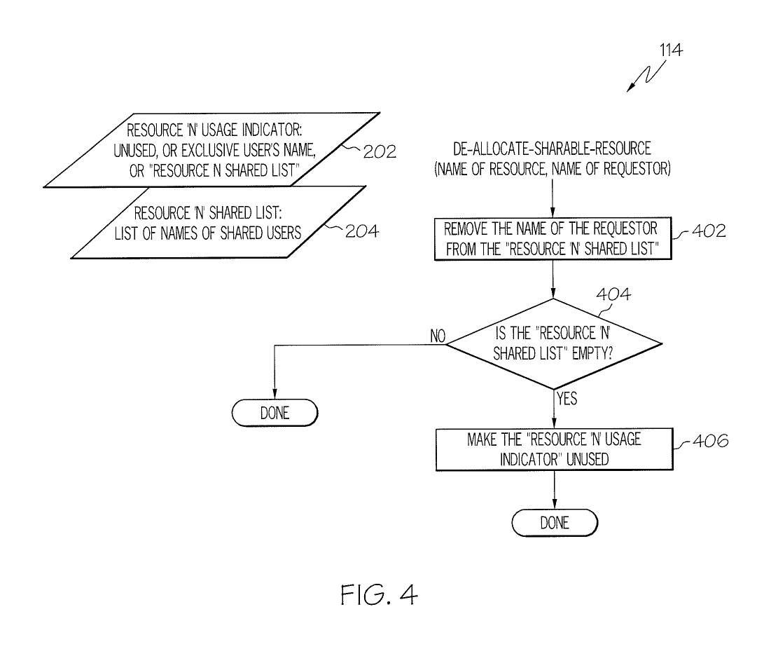

Returning now to step 104, if it is determined in step 104 that the request does not include a request to engage a requested use of the resource, then the process proceeds to the above-referenced step 108 of FIG. 1. In step 108, a determination is made as to whether the request includes a request to disengage a requested use of the resource. If a determination is made in step 108 that the request includes a request to disengage a requested use of the resource, then the process proceeds to step 114, in which a de-allocation algorithm is implemented. The de-allocation algorithm of step 114 is depicted in FIG. 4 in accordance with an exemplary embodiment of the present invention, and will be described further below in connection therewith. Conversely, if a determination is made in step 108 that the request does not include a request to disengage a requested use of the resource, then the process instead terminates.

It will be appreciated that, in certain embodiments, certain of the steps of the process 100 of FIG. 1 may vary. It will similarly be appreciated that certain steps of the process 100 of FIG. 1 may be conducted simultaneously with one another and/or in an otherwise different order than that depicted in the Figures or described herein.

Turning now to FIG. 2, a flowchart is provided of the exclusive allocation algorithm of step 110 of the process 100 of FIG. 1, in accordance with an exemplary embodiment of the present invention. As depicted in FIG. 2, the exclusive allocation algorithm of step 110 utilizes a resource usage indicator 202 and a resource shared list 204. In a preferred embodiment, the resource usage indicator 202 and the resource shared list 204 are stored in a memory of a computer system, such as the memory 508 of the computer system 500 of FIG. 5.

Also as depicted in FIG. 2, the exclusive allocation algorithm of step 110 begins with the step of determining whether the resource requested is already being used (step 206). In a preferred embodiment, this determination is made by a processor of a computer system, such as the processor 506 of the computer system 500 of FIG. 5.

If it is determined in step 206 that the resource is not already being used, then the resource is allocated for exclusive use by the use requested in the request (step 208). In addition, in such event, the name of the requester is preferably entered into the resource usage indicator 202 as part of this step. The resource is then considered to be successfully allocated in accordance with the request. In a preferred embodiment, the allocation of the resource for exclusive use and the entering of the name of the requester into the resource usage indicator 202 are performed by a processor of a computer system, such as the processor 506 of the computer system 500 of FIG. 5.

Conversely, if it is determined in step 206 that the resource is already being used, then a determination is made as to whether the resource is currently being shared (step 210). In a preferred embodiment, this determination is made by a processor of a computer system, such as the processor 506 of the computer system 500 of FIG. 5.

If it is determined in step 210 that the resource is not currently being shared, then a further determination is made as to whether the requested use from the request has a priority that is ranked higher than the exclusive existing use of the resource (step 212). In a preferred embodiment, this determination is made by a processor of a computer system, such as the processor 506 of the computer system 500 of FIG. 5. Conversely, if it is determined in step 210 that the resource is currently being shared, then the process proceeds instead to step 214, as discussed further below.

If it is determined in step 212 that the requested use from the request has a priority that is ranked higher than the exclusive existing use of the resource, the existing use is preempted from using the resource, and the requester is allowed to utilize the resource in accordance with the requested use from the request (step 216). Thus, in this circumstance, the resource is now allocated solely to the requested use. In addition, the name of the existing user is replaced with the name of the requester on the resource usage indicator 202 to represent the new allocation of the resource to the requested use. In a preferred embodiment, the allocation of the resource to the requested use and the replacement of the name of the existing user with the name of the requester in the resource usage indicator 202 in step 216 are performed by a processor of a computer system, such as the processor 506 of the computer system 500 of FIG. 5.

Conversely, if it is determined in step 212 that the requested use from the request has a priority that is not ranked higher than the exclusive existing use of the resource, the requester is denied from using the resource in accordance with the requested use from the request (step 218). Thus, in this circumstance, the resource continues to be allocated solely to the existing exclusive use. In a preferred embodiment, the denial of the requested use of the resource is performed by a processor of a computer system, such as the processor 506 of the computer system 500 of FIG. 5.

As mentioned above, if it is determined in step 210 that the resource is currently being shared, then the process proceeds to the above-mentioned step 214. In step 214, a determination is made as to whether the priority of the requested use is higher than the priorities of all of the existing shared uses of the resource. In a preferred embodiment, this determination is made by a processor of a computer system, such as the processor 506 of the computer system 500 of FIG. 5.

If it is determined in step 214 that the requested use from the request has a priority that is ranked higher than all of the existing shared uses of the resource, then each of the existing shared uses is pre-empted from using the resource, and the requester is allowed to utilize the resource in accordance with the requested use from the request (step 220). Thus, in this circumstance, the resource is now allocated solely to the requested use. In addition, the names of each of the existing shared users of the resource are removed from the resource shared list 204 and the resource usage indicator 202 is updated to include the name of the requestor. In a preferred embodiment, the allocation of the resource to the requested use and the updating of and placement of the name of the requester in the resource usage indicator 202 and the resource shared list 204 in step 220 are performed by a processor of a computer system, such as the processor 506 of the computer system 500 of FIG. 5.

Conversely, if it is determined in step 214 that the requested use from the request has a priority that is not ranked higher than all of the existing shared uses of the resource, then the requestor is denied from using the resource in accordance with the requested use from the request, as the process returns to the above-described step 218. Thus, in this circumstance, the resource continues to be allocated solely to the existing shared users, and not to the requested use. In a preferred embodiment, the denial of the requested use of the resource in step 218 is performed by a processor of a computer system, such as the processor 506 of the computer system 500 of FIG. 5.

It will be appreciated that, in certain embodiments, certain of the steps of the exclusive allocation algorithm of step 110 of FIG. 2 may vary. It will similarly be appreciated that certain steps of the exclusive allocation algorithm of step 110 of FIG. 2 may be conducted simultaneously with one another and/or in an otherwise different order than that depicted in the Figures or described herein.

Turning now to FIG. 3, a flowchart is provided of the non-exclusive allocation algorithm of step 112 of the process 100 of FIG. 1, in accordance with an exemplary embodiment of the present invention. As depicted in FIG. 3, the non-exclusive allocation algorithm of step 112 preferably utilizes the same resource usage indicator 202 and resource shared list 204 as the exclusive allocation algorithm of FIG. 2, and that are preferably stored in a memory of a computer system, such as the memory 508 of the computer system 500 of FIG. 5.

Also as depicted in FIG. 3, the non-exclusive allocation algorithm of step 112 begins with the step of determining whether the resource requested is already being used (step 302). In a preferred embodiment, this determination is made by a processor of a computer system, such as the processor 506 of the computer system 500 of FIG. 5.

If it is determined in step 302 that the resource is not already being used, then the resource is allocated for use by the use requested in the request, and for simultaneous shared use with any other applicable uses that may be requested by the requester and/or by another source (step 304). In addition, in such event, the name of the requester is entered into the resource shared list 204 and the resource shared list 204 is entered in the resource usage indicator 202, as part of this step. The resource is then considered to be successfully allocated in accordance with the request, and can also be utilized in connection with any other compatible uses. In a preferred embodiment, the allocation of the resource for exclusive use and the entering of the name of the requester into the resource usage indicator 202 and the resource shared list 204 in step 304 are performed by a processor of a computer system, such as the processor 506 of the computer system 500 of FIG. 5.

Conversely, if it is determined in step 302 that the resource is already being used, then a determination is made as to whether the existing use of the resource can be shared with the requested use (step 306). In a preferred embodiment, this determination is made by a processor of a computer system, such as the processor 506 of the computer system 500 of FIG. 5.

If it is determined in step 306 that the existing use of the resource can be shared with the requested use, then simultaneous use of the resource is allowed for both the requested use and the existing (step 307). Thus, the resource is shared between the existing use and the requested use in this circumstance. In addition, as part of this step, the requestor's name is preferably added to the resource shared list 204. In a preferred embodiment, this allocation of the resource for simultaneous use by the existing and requested uses in step 307 is performed by a processor of a computer system, such as the processor 506 of the computer system 500 of FIG. 5. Also in a preferred embodiment, the addition of the name of the requester to the resource shared list 204 in step 307 is also performed by a processor of a computer system, such as the processor 506 of the computer system 500 of FIG. 5.

Conversely, if it is determined in step 306 that the existing use of the resource cannot be shared with the requested use, then a determination is made as to whether the priority of the requested use is higher than the priority of the existing use (step 308). In a preferred embodiment, this determination is also performed by a processor of a computer system, such as the processor 506 of the computer system 500 of FIG. 5.

If it is determined in step 308 that the priority of the requested use is higher than the priority of the existing use, then the existing use is pre-empted from using the resource, and the requester is allowed to utilize the resource in accordance with the requested use from the request (step 310). Thus, in this circumstance, the resource is now allocated solely to the requested use and simultaneous shared use with any potential future valid request. In addition, the name of the requestor is included in the resource shared list 204, and the name of the existing user is replaced with the resource shared list on the resource usage indicator 202 to represent the new allocation of the resource to the requested use. In a preferred embodiment, the allocation of the resource to the requested use and the replacement of the name, in the resource usage indicator 202, of the existing user with the resource shared list 204, that has the name of the requester, in step 310 are performed by a processor of a computer system, such as the processor 506 of the computer system 500 of FIG. 5.

Conversely, if it is determined in step 308 that the priority of the requested use is not higher than the priority of the existing use, then the requester is denied from using the resource in accordance with the requested use from the request (step 312). Thus, in this circumstance, the resource continues to be allocated solely to the existing exclusive use. In a preferred embodiment, the denial of the requested use of the resource is performed by a processor of a computer system, such as the processor 506 of the computer system 500 of FIG. 5.

It will be appreciated that, in certain embodiments, certain of the steps of the non-exclusive allocation algorithm of step 112 of FIG. 3 may vary. It will similarly be appreciated that certain steps of the exclusive allocation algorithm of step 112 of FIG. 3 may be conducted simultaneously with one another and/or in an otherwise different order than that depicted in the Figures or described herein.

Turning now to FIG. 4, a flowchart is provided of the de-allocation algorithm of step 114 of the process 100 of FIG. 1, in accordance with an exemplary embodiment of the present invention. As depicted in FIG. 4, the de-allocation algorithm of step 114 preferably utilizes the same resource usage indicator 202 and resource shared list 204 as the exclusive allocation algorithm and the non-exclusive allocation algorithm of FIGS. 2 and 3, respectively, and that are preferably stored in a memory of a computer system, such as the memory 508 of the computer system 500 of FIG. 5.

Also as depicted in FIG. 4, the de-allocation algorithm of step 114 begins with the step of removing the name of the requestor from the resource shared list 204 (step 402). In a preferred embodiment, this removal of the requester form the resource shared list 204 is performed by a processor of a computer system, such as the processor 506 of the computer system 500 of FIG. 5.

A determination is then made as to whether the resource shared list 204 is now empty (step 404). In a preferred embodiment, this determination is performed by a processor of a computer system, such as the processor 506 of the computer system 500 of FIG. 5. If a determination is made in step 404 that the resource shared list 204 is not empty, then the process terminates. Conversely, if it is determined in step 404 that the resource shared list 204 is empty, then the resource usage indicator 202 is marked to show that the resource is currently unused (step 406), after which the process terminates. In a preferred embodiment, the marking of the resource usage indicator 202 in this manner in step 406 is also performed by a processor of a computer system, such as the processor 506 of the computer system 500 of FIG. 5.

It will be appreciated that, in certain embodiments, certain of the steps of the de-allocation algorithm of step 114 of FIG. 4 may vary. It will similarly be appreciated that certain steps of the de-allocation algorithm of step 114 of FIG. 4 may be conducted simultaneously with one another and/or in an otherwise different order than that depicted in the Figures or described herein.

FIG. 5 is a functional block diagram of a computer system 500 for allocating a plurality of uses for a resource of a vehicle. As mentioned above, the computer system 500 can be used in implementing the process 100 of FIG. 1, including steps 110, 112, and 114 thereof of FIGS. 2-4, in accordance with an exemplary embodiment of the present invention. In addition, program products or software associated with the computer system 500 (for example that includes the program 512 depicted in FIG. 5 and described further below) can also be used to implement the process 100 of FIG. 1 and/or the steps of FIGS. 2-4, among other processes and steps).

In the depicted embodiment, the computer system 500 includes a processor 506, a memory 508, a computer bus 510, an interface 513 (also as mentioned above), and a storage device 514. The processor 506 performs the computation and control functions of the computer system 500, and may comprise any type of processor or multiple processors, single integrated circuits such as a microprocessor, or any suitable number of integrated circuit devices and/or circuit boards working in cooperation to accomplish the functions of a processing unit. During operation, the processor 506 executes one or more programs 512 preferably stored within the memory 508 and, as such, controls the general operation of the computer system 500.

The memory 508 stores a program or programs 512 that executes one or more embodiments of processes such as the process 100 depicted in FIG. 1 and described above in connection therewith, and/or various steps thereof and/or other processes. The memory 508 can be any type of suitable memory. This would include the various types of dynamic random access memory (DRAM) such as SDRAM, the various types of static RAM (SRAM), and the various types of non-volatile memory (PROM, EPROM, and flash). It should be understood that the memory 508 may be a single type of memory component, or it may be composed of many different types of memory components. In addition, the memory 508 and the processor 506 may be distributed across several different computers that collectively comprise the computer system 500. For example, a portion of the memory 508 may reside on a computer within a particular apparatus or process, and another portion may reside on a remote computer.

The computer bus 510 serves to transmit programs, data, status and other information or signals between the various components of the computer system 500. The computer bus 510 can be any suitable physical or logical means of connecting computer systems and components. This includes, but is not limited to, direct hard-wired connections, fiber optics, infrared and wireless bus technologies.

The interface 513 allows communication to the computer system 500, for example from a system operator and/or another computer system, and can be implemented using any suitable method and apparatus. It can include one or more network interfaces to communicate with the requester, or with one or more terminal interfaces to communicate with technicians, and/or one or more storage interfaces to connect to storage apparatuses such as the storage device 514, and/or one or more other components of the computer system 500 and/or other systems and/or devices.

The storage device 514 can be any suitable type of storage apparatus, including direct access storage devices such as hard disk drives, flash systems, floppy disk drives and optical disk drives. In one exemplary embodiment, the storage device 514 is a program product from which memory 508 can receive a program 512 that executes one or more embodiments of the process and/or steps thereof as described in greater detail further below. In one preferred embodiment, such a program product can be implemented as part of, inserted into, or otherwise coupled to the computer system 500 and/or one or more components thereof. As shown in FIG. 5, the storage device 514 can comprise a disk drive device that uses disks 515 to store data. As one exemplary implementation, the computer system 500 may also utilize an Internet website, for example for providing or maintaining data or performing operations thereon.

It will be appreciated that while this exemplary embodiment is described in the context of a fully functioning computer system, those skilled in the art will recognize that the mechanisms of the present invention are capable of being distributed as a program product in a variety of forms, and that the present invention applies equally regardless of the particular type of computer-readable signal bearing media used to carry out the distribution. Examples of signal bearing media include: recordable media such as floppy disks, hard drives, memory cards and optical disks (e.g., disk 515), and transmission media such as digital and analog communication links. It will similarly be appreciated that the computer system 500 may also otherwise differ from the embodiment depicted in FIG. 5, for example in that the computer system 500 may be coupled to or may otherwise utilize one or more remote computer systems and/or other control systems.

Accordingly, an improved method for allocating a resource in a vehicle among a plurality of uses for the resource is provided. An improved program product is also provided for implementing such an improved method. In addition, an improved system is provided for allocating such a resource in a vehicle among such a plurality of uses. The provided method, program product, and system provide for potentially improved allocation of resources among multiple potential uses, and allows for the simultaneous use and coordination of a vehicle resource among multiple uses in situations in which such simultaneous uses are optimal.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A method for implementing a request pertaining to a requested use of a plurality of uses of a resource of a vehicle, the method comprising the steps of:
determining whether the resource is configured for simultaneous use by two or more of the plurality of uses;
determining whether the resource is being used by an existing use of the plurality of uses; and
allowing the requested use of the resource and the existing use of the resource, if the resource is configured for simultaneous use by two or more of the plurality of uses and the resource is being used by the existing use.

2. The method of claim 1, further comprising the step of:
allowing the requested use, if the resource is not being used by the existing use.

3. The method of claim 2, further comprising the step of:
determining relative priorities of the requested use and the existing use.

4. The method of claim 3, further comprising the step of:
allowing the requested use but not the existing use, if the requested use has a higher relative priority than the existing use.

5. The method of claim 4, further comprising the step of:
allowing the existing use but not the requested use, if both of the following conditions are satisfied:
the resource is being used by the existing use; and
the existing use has a higher relative priority than the requested use.

6. The method of claim 5, further comprising the step of:
activating the requested use of the resource, if the request is for activation of the requested use of the resource and the requested use of the resource is allowed.

7. The method of claim 6, further comprising the step of:
de-activating the requested use of the resource, if the request is for de-activation of the requested use of the resource.

8. A program product for implementing a request pertaining to a requested use of a plurality of uses of a resource of a vehicle, the program product comprising:
(a) a program configured to at least facilitate:
determining whether the resource is configured for simultaneous use by two or more of the plurality of uses;
determining whether the resource is being used by an existing use of the plurality of uses; and
allowing the requested use of the resource and the existing use of the resource, if the resource is configured for simultaneous use by two or more of the plurality of uses and the resource is being used by the existing use; and
(b) a computer-readable signal bearing media bearing the program.

9. The program product of claim 8, wherein the program is further configured to at least facilitate allowing the requested use, if the resource is not being used by the existing use.

10. The program product of claim 9, wherein the program is further configured to at least facilitate determining relative priorities of the requested use and the existing use.

11. The program product of claim 10, wherein the program is further configured to at least facilitate allowing the requested use but not the existing use, if the requested use has a higher relative priority than the existing use.

12. The program product of claim 11, wherein the program is further configured to at least facilitate allowing the existing use but not the requested use, if both of the following conditions are satisfied:
the resource is being used by the existing use; and
the existing use has a higher relative priority than the requested use.

13. The program product of claim 12, wherein the program is further configured to at least facilitate activating the requested use of the resource, if the request is for activation of the requested use of the resource and the requested use of the resource is allowed.

14. The program product of claim 13, wherein the program is further configured to at least facilitate de-activating the requested use of the resource, if the request is for de-activation of the requested use of the resource.

15. A system for allocating a resource of a vehicle among a plurality of uses of the resource, the system comprising;
an interface configured to receive a request pertaining to a requested use of the plurality of uses; and
a processor coupled to the interface, the processor configured to at least facilitate:
determining whether the resource is configured for simultaneous use by two or more of the plurality of uses;
determining whether the resource is being used by an existing use of the plurality of uses; and
allowing the requested use of the resource and the existing use of the resource, if the resource is configured for simultaneous use by two or more of the plurality of uses and the resource is being used by the existing use.

16. The system of claim 15, wherein the processor is further configured to at least facilitate allowing the requested use, if the resource is not being used by the existing use.

17. The system of claim 16, wherein the processor is further configured to at least facilitate:
determining relative priorities of the requested use and the existing use; and
allowing the requested use but not the existing use, if the requested use has a higher relative priority than the existing use.

18. The system of claim 17, wherein the processor is further configured to at least facilitate allowing the existing use but not the requested use, if both of the following conditions are satisfied:
the resource is being used by the existing use; and
the existing use has a higher relative priority than the requested use.

19. The system of claim 18, wherein the processor is further configured to at least facilitate activating the requested use of the resource, if the request is for activation of the requested use of the resource and the requested use of the resource is allowed.

20. The system of claim 19, wherein the processor is further configured to at least facilitate de-activating the requested use of the resource, if the request is for de-activation of the requested use of the resource.
